(19) United States
(12) Patent Application Publication
(10) Pub. No.: US 2019/0380108 A1
(43) Pub. Date: Dec. 12, 2019

(54) MASTER BASE STATION, SECONDARY BASE STATION, AND METHOD

(71) Applicant: NEC CORPORATION, Tokyo (JP)

(72) Inventor: Masahiro KOMATSU, Tokyo (JP)

(73) Assignee: NEC CORPORATION, Tokyo (JP)

(21) Appl. No.: 16/426,145

(22) Filed: May 30, 2019

(30) Foreign Application Priority Data
Jun. 7, 2018 (JP) 2018-109733

(51) Int. Cl. H04W 68/00; H04W 56/00; H04W 80/02; H04W 80/08; H04L 1/16

(52) U.S. Cl. CPC H04W 68/005; H04W 56/005; H04W 56/003; H04W 84/20; H04W 80/08; H04L 1/1642; H04W 80/02

(57) ABSTRACT

An example object of the present application is to enable a master base station to obtain, at an appropriate timing, a transmission status or a delivery status of data transmitted from a secondary base station to a terminal apparatus.

There is provided a master base station 100 including: a controller configured to: obtain a message that requests a notification relating to a status of at least one of a data transmission status from a secondary base station 200 to a terminal apparatus 300 and a data delivery status from the secondary base station 200 to the terminal apparatus 300; and transmit the message to the secondary base station 200. The message includes timing indication information that indicates a timing of the notification to the secondary base station 200.

### BACKGROUND

### Technical Field

The present disclosure relates to a master base station, a secondary base station, and a method.

### Background Art

In mobile communication systems which perform simultaneous communication with multiple base stations (Dual Connectivity), data communication is realized using two eNBs, which are a Master-eNB (MeNB) and a Secondary-eNB (SeNB). Since user data of the same bearer is transmitted from the two eNBs, the MeNB will be the branching point of user data transport. That is, downlink data forwarded from a serving gateway (S-GW) via an S1 interface is transported over a carrier of the MeNB or transmitted to the SeNB side via an X2 interface and then transported over a carrier of the SeNB.

In order to realize this data communication, it is required to appropriately distribute amounts of user data transmitted over the respective carriers of the MeNB and the SeNB. For this purpose, flow control is performed in which the SeNB notifies the MeNB of transmission status and delivery status of user data transmitted from the SeNB side, acceptable amount of data buffer in the SeNB, and the like.

In addition, PTL 1 discloses that a transmitting unit of a radio base station MeNB notifies a radio base station SeNB of a receiving state of RLC-PDUs (uplink data signal) received from a mobile station UE.
[PTL 1] JP 2015-070318 A

### SUMMARY

Here, when viewed from a master base station, an update timing such as statuses of transmission and/or delivery performed by a secondary base station is irregular. In other words, a notification request of a transmission status or a delivery status from the master base station to the secondary base station is asynchronous with updates actually made by the secondary base station side.

Therefore, for example, a master base station is unable to immediately recognize a transmission status or a delivery status in a case where an interval between notification requests of the transmission status or the delivery status is long. Thus, there is a problem about a situation where the amounts of user data cannot be appropriately distributed. On the other hand, in a case where the interval between notification requests of the transmission status or the delivery status is short, similar notification requests are repeatedly issued even when the transmission status or the delivery status is not changed. This leads to a problem of becoming overloaded with traffic.

An example object of the present disclosure is to provide a master base station, a secondary base station, and a method that enable the master base station to obtain, at an appropriate timing, a transmission status or a delivery status of data transmitted from the secondary base station to a terminal apparatus.

According to a first example aspect of the present disclosure, there is provided a master base station which performs wireless communication with a terminal apparatus, the master base station including: a controller configured to: obtain a message that requests a notification from a secondary base station which performs wireless communication with the terminal apparatus, the notification relating to a status of at least one of a data transmission status from the secondary base station to the terminal apparatus and a data delivery status from the secondary base station to the terminal apparatus; and transmit the message to the secondary base station, wherein the message includes timing indication information that indicates a timing of the notification to the secondary base station.

According to a second example aspect of the present disclosure, there is provided a secondary base station which performs wireless communication with a terminal apparatus, the secondary base station including: a controller configured to: receive a message from a master base station which performs wireless communication with the terminal apparatus, the message requesting a notification relating to a status of at least one of a data transmission status from the secondary base station to the terminal apparatus and a data delivery status from the secondary base station to the terminal apparatus; and transmit information to the master base station in accordance with the message, the information relating to a status of at least one of the data transmission status and the data delivery status, wherein the message includes timing indication information that indicates a timing of the notification to the secondary base station, and the controller is configured to transmit the information relating to a status of at least one of the data transmission status and the data delivery status to the master base station at the timing indicated by the timing indication information.

According to a third example aspect of the present disclosure, there is provided a method performed by a master base station which performs wireless communication with a terminal apparatus, the method including: obtaining a message that requests a notification from a secondary base station which performs wireless communication with the terminal apparatus, the notification relating to a status of at least one of a data transmission status from the secondary base station to the terminal apparatus and a data delivery status from the secondary base station to the terminal apparatus; and transmitting the message to the secondary base station, wherein the message includes timing indication information that indicates a timing of the notification to the secondary base station.

According to a fourth example aspects of the present disclosure, there may be provided a method performed by a secondary base station which performs wireless communication with a terminal apparatus, the method including the actions of the secondary base station of the above second example aspect. According to further example aspects of the present disclosure, there may be provided a program causing the master or secondary base station to execute the actions of the master or secondary base station of the above first or second example aspect, and there may be provided a computer-readable non-transitory recording medium having recorded thereon such a program.

According to example embodiments of the present disclosure, it will be possible for a master base station to obtain, at an appropriate timing, a transmission status or a delivery status of data transmitted from a secondary base station to a terminal apparatus. Note that example embodiments of the present disclosure may exert other advantageous effects instead of the above advantageous effect or together with the above advantageous effect.

### BRIEF DESCRIPTION OF THE DRAWINGS

FIG. 1 is a diagram illustrating a schematic configuration of a mobile communication system that uses Dual Connectivity;

FIG. 2 is a diagram for describing a flow of user data in Dual Connectivity;

FIG. 3 is a diagram illustrating an example of a data format for report polling;

FIG. 4 is a diagram illustrating an example of a data format for a notification response;

FIG. 5 is a diagram illustrating a timing chart for describing flows of respective processes performed by an MeNB, a SeNB, and UE;

FIG. 6 is an explanatory diagram illustrating an example of a schematic configuration of a system 1 according to example embodiments of the present invention;

FIG. 7 is a block diagram illustrating an example of a schematic configuration of a master base station 100 according to a first example embodiment;

FIG. 8 is a block diagram illustrating an example of a schematic configuration of a secondary base station 200 according to the first example embodiment;

FIG. 9 is a diagram illustrating an example of a data format for transmitting a message;

FIG. 10 is a diagram illustrating a timing chart illustrating flows of processes according to a first specific example;

FIG. 11 is a diagram illustrating a timing chart illustrating flows of processes according to a second specific example;

FIG. 12 is a diagram illustrating a timing chart illustrating flows of processes according to a third specific example;

FIG. 13 is a block diagram illustrating an example of a schematic configuration of a master base station 100 according to a second example embodiment; and

FIG. 14 is a block diagram illustrating an example of a schematic configuration of a secondary base station 200 according to the second example embodiment.

### DESCRIPTION OF THE EXAMPLE EMBODIMENTS

Example embodiments of the present invention will be described in detail below with reference to the accompanying drawings. Note that, in the present Specification and drawings, elements to which similar descriptions are applicable are denoted by the same reference signs, whereby overlapping descriptions may be omitted.

Descriptions will be given in the following order.

1. Overview of Example Embodiments of Present Invention

2. Configuration of System

3. First Example Embodiment
3.1. Configuration of Master Base Station 100
3.2. Configuration of Secondary Base Station 200
3.3. Technical Features
3.4. Specific Examples

4. Second Example Embodiment
4.1. Configuration of Master Base Station 100
4.2. Configuration of Secondary Base Station 200
4.3. Technical Features

5. Another Example Embodiment

### Overview of Example Embodiments of Present Invention

First, an overview of example embodiments of the present invention will be described.

### (1) Technical Problem

In mobile communication systems which perform simultaneous communication with multiple base stations (Dual Connectivity), data communication is realized using two eNBs, which are a Master-eNB (MeNB) and a Secondary-eNB (SeNB).

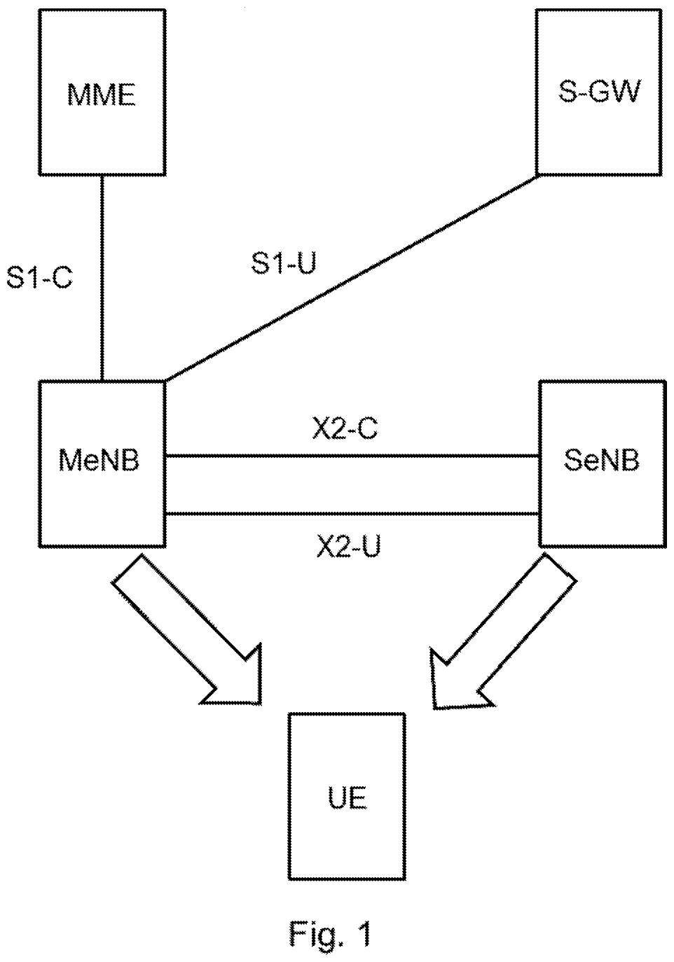

FIG. 1 is a diagram illustrating a schematic configuration of a mobile communication system that uses Dual Connectivity.

As illustrated in FIG. 1, since user data of the same bearer is transmitted from the two eNBs, the MeNB will be the branching point of user data transport. That is, downlink data forwarded from a serving gateway (S-GW) via an S1 interface is transported over a carrier of the MeNB or transmitted to the SeNB side via an X2 interface and then transported over a carrier of the SeNB.

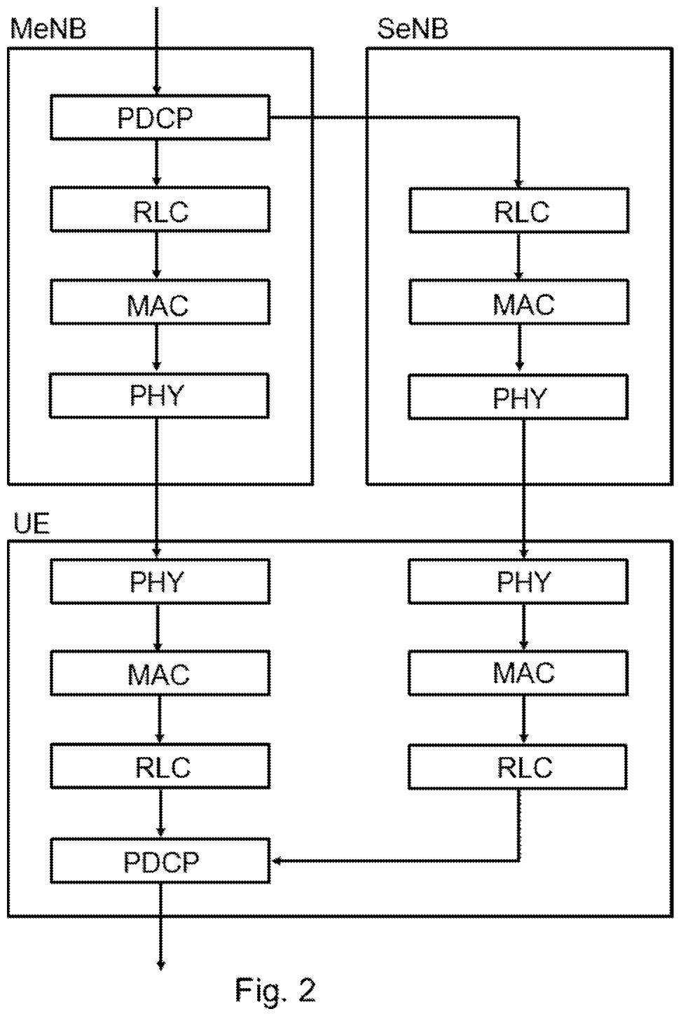

FIG. 2 is a diagram for describing a flow of user data in Dual Connectivity.

As illustrated in FIG. 2, the eNB side is configured such that protocol stacks are separated below a Packet Data Convergence Protocol (PDCP) layer in the MeNB and that a Radio Link Control (RLC) layer, a Medium Access Control (MAC) layer, and a physical (PHY) layer are installed in each of the MeNB and the SeNB. In the UE side, protocol layers corresponding to the above-described layers are prepared.

In order to realize such data communication, it is required to appropriately distribute respective amounts of user data transmitted over the carriers of the MeNB and the SeNB. For this purpose, flow control is performed in which the SeNB notifies the MeNB of transmission status and delivery status of user data transmitted from the SeNB side, acceptable amount of data buffer in the SeNB, and the like.

Specifically, a PDCP sequence number (SN) is given to user data when transmitting the user data from PDCP to RLC.

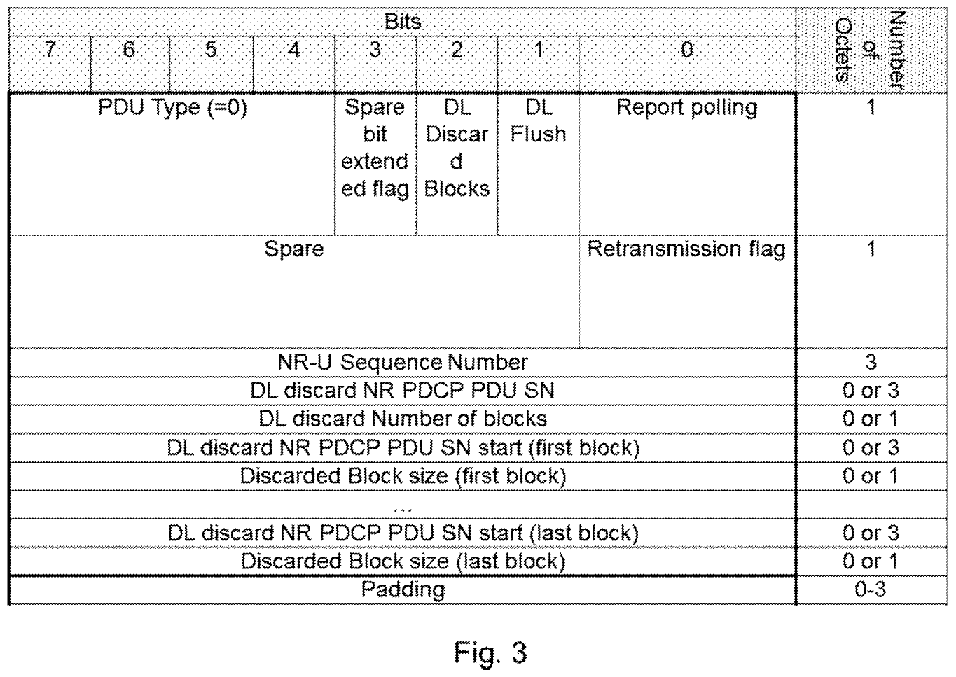

In addition, the MeNB configures report polling to make PDCP of the MeNB issue a notification request of a transmission status and/or a delivery status to RLC of the SeNB. FIG. 3 is a diagram illustrating an example of a data format for the report polling.

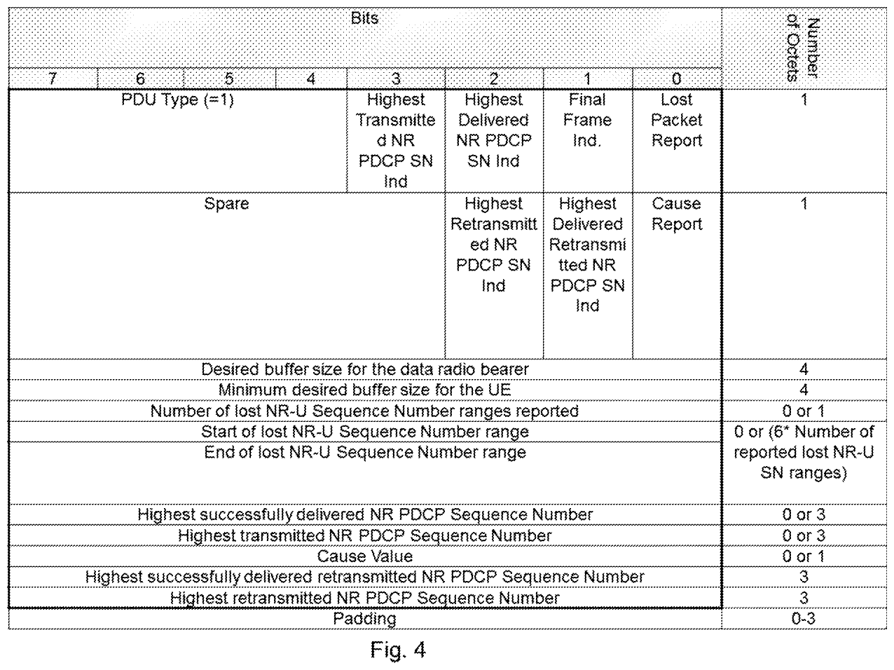

On the other hand, the SeNB immediately issues a notification response of the transmission status and/or the delivery status by using the PDCP SN in response to the request from the MeNB. FIG. 4 is a diagram illustrating an example of a data format for the notification response. That is, as illustrated in FIG. 4, the data format for the notification response includes PDCP SNs (Highest successfully delivered NR PDCP Sequence Number and Highest successfully delivered retransmitted NR PDCP Sequence Number) of delivery-acknowledged user data that represent delivery statuses, PDCP SNs (Highest transmitted NR PDCP Sequence Number and Highest retransmitted NR PDCP Sequence Number) of transmitted user data that represent transmission statuses, buffer sizes (Desired buffer size for the data bearer and Minimum desired buffer size for the UE) that represent acceptable amounts of data buffer, and the like.

The mechanism of acknowledging delivery at RLC is configured such that, for example, successful or failed delivery of user data is recognized by requesting an RLC status from the opposite RLC layer (the RLC layer on the UE side) and receiving the RLC status from the opposite RLC layer (the RLC layer on the UE side).

Here, the RLC status is requested from the opposite RLC layer (the RLC layer on the UE side) when a given number of pieces of user data is transmitted, or when user data is transmitted up to the upper limit of a transmission window and no more pieces of user data can be transmitted, for example.

In addition, the SeNB transmits user data at the RLC layer or requests the RLC status from the opposite RLC layer (the RLC layer of the UE side) when a radio resource is allocated by scheduling at the MAC layer.

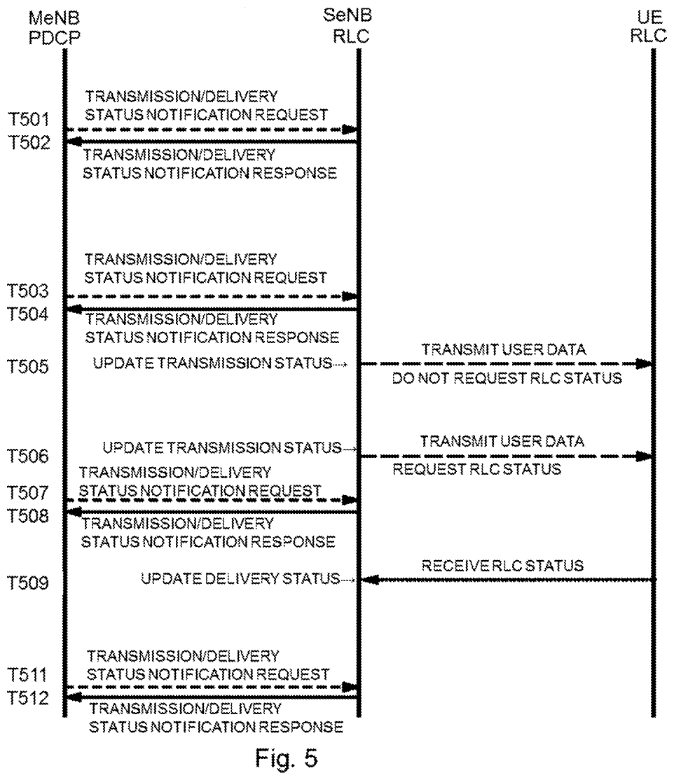

Next, with reference to FIG. 5, flows of respective processes performed by the MeNB, the SeNB, and the UE will be described. FIG. 5 is a diagram illustrating a timing chart for describing the flows of the respective processes performed by the MeNB, the SeNB, and the UE.

At a time T501, a PDCP layer processing section of the MeNB issues a notification request of a transmission status and/or a delivery status to an RLC layer processing section of the SeNB.

At a time T502, the RLC layer processing section of the SeNB immediately issues a notification response of the transmission status and/or the delivery status by using the PDCP SN in response to the notification request.

At a time T503, the PDCP layer processing section of the MeNB issues a notification request of a transmission status and/or a delivery status to the RLC layer processing section of the SeNB.

At a time T504, the RLC layer processing section of the SeNB immediately issues a notification response of the transmission status and/or the delivery status by using the PDCP SN in response to the notification request made at the time T503. Here, the RLC layer processing section of the SeNB does not update the transmission status and/or the delivery status. Accordingly, the transmission status and/or the delivery status is the same as those of the time T502.

At a time T505, the RLC layer processing section of the SeNB does not request an RLC status but transmits user data to an RLC layer processing section of the UE. In such a way, the transmission status is updated.

At a time T506, the RLC layer processing section of the SeNB determines whether a given amount of user data has been transmitted to the UE since the RLC status has been requested in the past, whether a given number of pieces of user data has been transmitted to the UE, whether the last user data has been transmitted to the UE, or whether user data has been transmitted to the UE up to the upper limit of the transmission window and no more pieces of user data can be transmitted, for example. Subsequently, when a condition for a trigger for requesting an RLC status is satisfied, the RLC layer processing section of the SeNB transmits user data to the UE along with an RLC status request. In such a way, the transmission status is updated.

At a time T507, the PDCP layer processing section of the MeNB issues a notification request of a transmission status and/or a delivery status to the RLC layer processing section of the SeNB.

At a time T508, the RLC layer processing section of the SeNB immediately issues a notification response of the transmission status and/or the delivery status by using the PDCP SN in response to the notification request made at the time T507. Specifically, the PDCP layer processing section of the MeNB is notified of the transmission status updated at the time T506.

At a time T509, the RLC layer processing section of the SeNB receives an RLC status from the UE. In such a way, the delivery status is updated.

At a time T510, the PDCP layer processing section of the MeNB issues a notification request of a transmission status and/or a delivery status to the RLC layer processing section of the SeNB.

At a time T511, the RLC layer processing section of the SeNB immediately issues a notification response of the transmission status and/or the delivery status by using the PDCP SN in response to the notification request made at the time T510. Specifically, the PDCP layer processing section of the MeNB is notified of the delivery status updated at the time T509.

The processes illustrated in FIG. 5 use the eNBs (E-UTRAN Node Bs) as the base stations. However, it is also possible to use generation Node Bs (gNBs). In addition, it is also possible to establish Dual Connectivity by using three or more base stations.

In the processes illustrated in FIG. 5, the timing of updating the transmission status and/or delivery status by the SeNB is irregular, when viewed from the MeNB. In other words, notification requests of a transmission status or a delivery status from the MeNB to the SeNB is asynchronous with updates actually done by the SeNB side.

Therefore, for example, the MeNB is unable to immediately recognize the transmission status or the delivery status in a case where an interval between notification requests of a transmission status or a delivery status is long. Thus, there is a problem about a situation where amounts of user data cannot be appropriately distributed. On the other hand, in a case where the interval between notification requests of a transmission status or a delivery status is short, similar notification requests are repeatedly issued even when the transmission status or the delivery status is not changed. This leads to a problem of becoming overloaded with traffic.

Accordingly, an example object of the example embodiments is to enable a master base station (such as the MeNB) to obtain, at an appropriate timing, a transmission status or a delivery status of data transmitted from a secondary base station (Such as the SeNB) to a terminal apparatus (such as the UE).

### (2) Technical Features

For example, according to example embodiments, the master base station performs wireless communication with a terminal apparatus, and the master base station includes: an obtaining section configured to obtain a message that requests a notification from the secondary base station which performs wireless communication with the terminal apparatus, the notification relating to a status of at least one of a data transmission status from the secondary base station to the terminal apparatus and a data delivery status from the secondary base station to the terminal apparatus; and a transmission processing section configured to transmit the message to the secondary base station. The message includes timing indication information that indicates a timing of the notification to the secondary base station.

In this way, for example, it will be possible for the master base station to obtain, at an appropriate timing, a transmission status or a delivery status of data transmitted from the secondary base station to the terminal apparatus.

Note that the above-described technical features are a specific example of the example embodiments according to the present invention. The example embodiments of the present invention are not limited to the above-described technical features.

### 2. Configuration of System

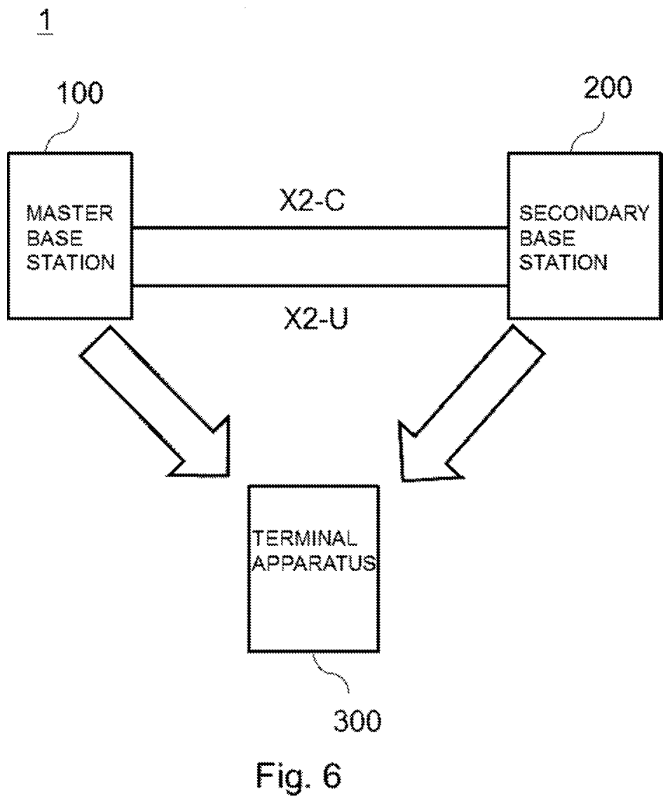

With reference to FIG. 6, an example of a configuration of the system 1 according to example embodiments of the present invention will be described. FIG. 6 is an explanatory diagram illustrating an example of a schematic configuration of the system 1 according to example embodiments of the present invention. With reference to FIG. 6, the system 1 includes a master base station 100, a secondary base station 200, and a terminal apparatus 300.

For example, the system 1 is a system that conforms to 3rd Generation Partnership Project (3GPP) standards/specifications. More specifically, for example, the system 1 may be a system that conforms to LTE, LTE-Advanced, and/or System Architecture Evolution (SAE) standards/specifications. Alternatively, the system 1 may be a system that conforms to 5th Generation (5G)/New Radio (NR) standards/specifications. Naturally, the system 1 is not limited thereto.

In addition, the system 1 is a mobile communication system which performs simultaneous communication with multiple base stations (Dual Connectivity). The system 1 establishes data communication using two base stations, which are the master base station 100 and the secondary base station 200. Here, since user data of the same bearer is transmitted from the two base stations, the master base station 100 will be the branching point of user data transport. That is, the user data is transported over a carrier of the master base station 100, or the user data is transmitted to the secondary base station 200 side via an X2 interface and then transported over a carrier of the secondary base station 200.

In order to establish this data communication, it is necessary to appropriately distribute respective amounts of user data transmitted over the carriers of the master base station 100 and the secondary base station 200. For this purpose, flow control is performed in which the SeNB notifies the MeNB of a transmission status and a delivery status of user data transmitted from the secondary base station 200 side, acceptable amount of data buffer in the secondary base station 200, and the like.

### (1) Master Base Station 100 and Secondary Base Station 200

Each of the master base station 100 and the secondary base station 200 is a node for a radio access network (RAN), and performs wireless communication with a terminal apparatus (such as the terminal apparatus 300) in a coverage area.

For example, each of the master base station 100 and the secondary base station 200 may be an evolved Node B (eNB) or a generation Node B (gNB) in 5G. The master base station 100 may include multiple units (or multiple nodes). The multiple units (or the multiple nodes) may include a first unit (or a first node) configured to perform a process of a higher protocol layer and a second unit (or a second node) configured to perform a process of a lower protocol layer. For example, the first unit may be referred to as a center/central unit (CU), and the second unit may be referred to as a distributed unit (DU) or an access unit (AU). As another example, the first unit may be referred to as a digital unit (DU), and the second unit may be referred to as a radio unit (RU) or a remote unit (RU). The digital unit (DU) may be a baseband unit (BBU), and the RU may be a remote radio head (RRH) or a remote radio unit (RRU). Naturally, the names of the first unit (or the first node) and the second unit (or the second node) are not limited to such examples. Alternatively, each of the master base station 100 and the secondary base station 200 may be a single unit (or a single node). In this case, the master base station 100 may be one of the above-described multiple units (for example, one of the first unit and the second unit), and may be connected to the other of the multiple unit (for example, the other of the first unit and the second unit).

### (2) Terminal Apparatus 300

The terminal apparatus 300 performs wireless communication with the base stations. For example, the terminal apparatus 300 performs wireless communication with a base station in a case where the terminal apparatus 300 is in a coverage area of the base station (such as the master base station 100 or the secondary base station 200). For example, the terminal apparatus 300 may be user equipment (UE).

### First Example Embodiment

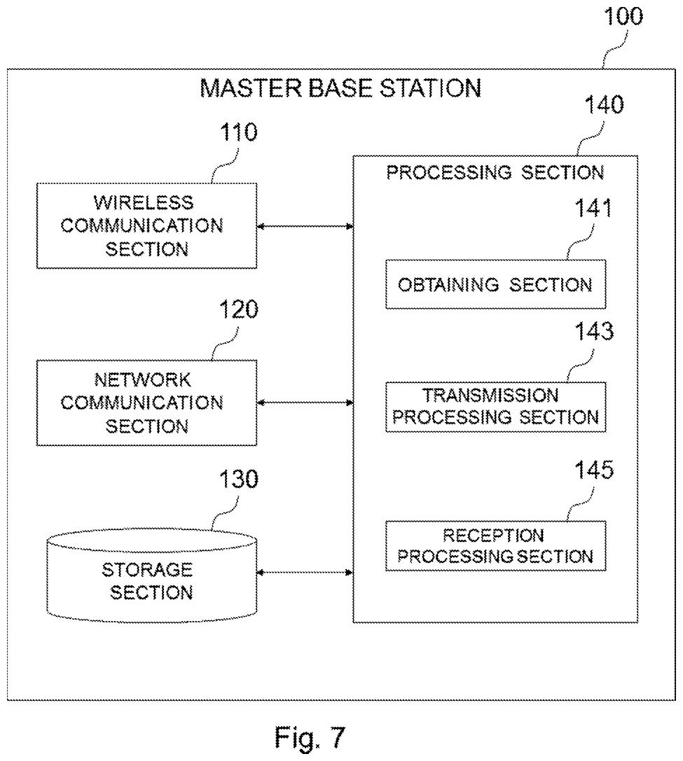

Next, a first example embodiment of the present invention will be described with reference to FIG. 7 to FIG. 12.

### <3.1. Configuration of Master Base Station 100>

First, with reference to FIG. 7, an example of a configuration of a master base station 100 according to the first example embodiment will be described. FIG. 7 is a block diagram illustrating an example of a schematic configuration of the master base station 100 according to the first example embodiment. With reference to FIG. 7, the master base station 100 includes a wireless communication section 110, a network communication section 120, a storage section 130, and a processing section 140.

### (1) Wireless Communication Section 110

The wireless communication section 110 wirelessly transmits and receives signals. For example, the wireless communication section 110 receives a signal from a terminal apparatus and transmits a signal to the terminal apparatus.

### (2) Network Communication Section 120

The network communication section 120 receives a signal from a network and transmits a signal to the network. For example, the network communication section 120 receives a signal from the secondary base station 200 and transmits a signal to the secondary base station 200.

### (3) Storage Section 130

The storage section 130 stores a program (instructions) and parameters for operation of the master base station 100 as well as various kinds of data temporarily or permanently. The program includes one or more instructions for operation of the master base station 100.

### (4) Processing Section 140

The processing section 140 provides various functions of the master base station 100.

The processing section 140 includes an obtaining section 141, a transmission processing section 143, and a reception processing section 145. Note that the processing section 140 may further include another constituent element than the above-described constituent elements. That is, the processing section 140 may perform operations other than the operations of the above-described constituent elements. Specific operations of the obtaining section 141, the transmission processing section 143, and the reception processing section 145 will be described later in detail.

For example, the processing section 140 (the transmission processing section 143 and the reception processing section 145) communicates with a terminal apparatus (such as the terminal apparatus 300) via the wireless communication section 110. For example, the processing section 140 (the transmission processing section 143 and the reception processing section 145) communicates with another network node (such as the secondary base station 200) via the network communication section 120.

### (5) Implementation Example

The wireless communication section 110 may be implemented with an antenna, a high frequency (radio frequency (RF)) circuit, and the like. The antenna may be a directional antenna. The network communication section 120 may be implemented with a network adapter, a network interface card, and/or the like. The storage section 130 may be implemented with memory (for example, non-volatile memory and/or volatile memory), hard disk, and/or the like. The processing section 140 may be implemented with one or more processors such as baseband (BB) processors, another type of processors, and/or the like. The obtaining section 141, the transmission processing section 143, and the reception processing section 145 may be implemented with the same processor or may be implemented with respective different processors. The memory (the storage section 130) may be included in the one or more processors or may be external to the one or more processors.

The master base station 100 may include a memory that stores programs (instructions) and one or more processors that are capable of executing the programs (instructions). The one or more processors may execute the programs to perform operations of the processing section 140 (operations of the obtaining section 141, the transmission processing section 143, and/or the reception processing section 145). The programs may be programs for causing the processors to execute the operations of the processing section 140 (operations of the obtaining section 141, the transmission processing section 143, and/or the reception processing section 145).

Note that the master base station 100 may be virtualized. That is, the master base station 100 may be implemented as a virtual machine. In this case, the master base station 100 (virtual machine) may operate as a virtual machine on a hypervisor or on a physical machine (hardware) including a processor, memory and the like.

### <3.2. Configuration of Secondary Base Station 200>

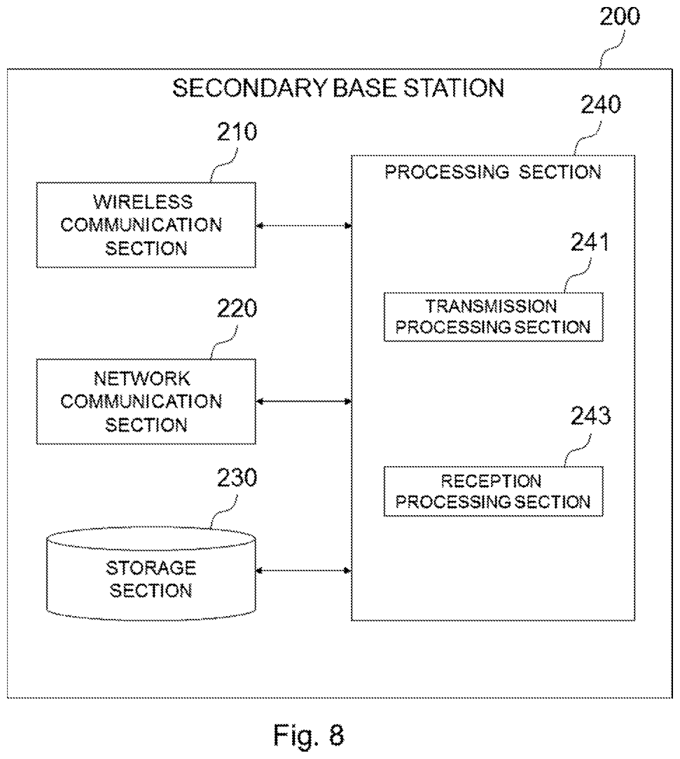

Next, with reference to FIG. 8, an example of a configuration of the secondary base station 200 according to the first example embodiment will be described. FIG. 8 is a block diagram illustrating an example of a schematic configuration of the secondary base station 200 according to the first example embodiment. With reference to FIG. 8, the secondary base station 200 includes a wireless communication section 210, a network communication section 220, a storage section 230, and a processing section 240.

### (1) Wireless Communication Section 210

The wireless communication section 210 wirelessly transmits/receives signals. For example, the wireless communication section 210 receives a signal from a terminal apparatus and transmits a signal to the terminal apparatus.

### (2) Network Communication Section 220

The network communication section 220 receives a signal from a network and transmits a signal to the network. For example, the network communication section 220 receives a signal from the master base station 100 and transmits a signal to the master base station 100.

### (3) Storage Section 230

The storage section 230 stores a program (instructions) and parameters for operation of the secondary base station 200 as well as various kinds of data temporarily or permanently. The program includes one or more instructions for operation of the master base station 100.

### (4) Processing Section 240

The processing section 240 provides various functions of the secondary base station 200. The processing section 240 includes a transmission processing section 241 and a reception processing section 243. Note that the processing section 240 may further include another constituent element than the above-described constituent elements. That is, the processing section 240 may perform operations other than the operations of the above-described constituent elements. Specific operations of the transmission processing section 241 and the reception processing section 243 will be described later in detail.

For example, the processing section 240 (the transmission processing section 241 and the reception processing section 243) communicates with a terminal apparatus (such as the terminal apparatus 300) via the wireless communication section 210. For example, the processing section 240 (the transmission processing section 241 and the reception processing section 243) communicates with another network node (such as the master base station 100) via the network communication section 220.

### (5) Implementation Example

The wireless communication section 210 may be implemented with an antenna, a high frequency (radio frequency (RF)) circuit, and the like. The antenna may be a directional antenna. The network communication section 220 may be implemented with a network adapter, a network interface card and/or the like. The storage section 230 may be implemented with memory (for example, non-volatile memory and/or volatile memory), hard disk, and/or the like. The processing section 240 may be implemented with one or more processors such as baseband (BB) processors, another type of processors, and/or the like. The transmission processing section 241 and the reception processing section 243 may be implemented with the same processor or may be implemented with respective different processors. The memory (the storage section 230) may be included in the one or more processors or may be external to the one or more processors.

The secondary base station 200 may include a memory that stores a program (instructions), and one or more processors that are capable of executing the program (instructions). The one or more processors may execute the program to perform operations of the processing section 240 (operations of the transmission processing section 241 and/or the reception processing section 243). The program may be a program for causing the processor to execute the operations of the processing section 240 (operations of the transmission processing section 241 and/or the reception processing section 243).

Note that the secondary base station 200 may be virtualized. That is, the secondary base station 200 may be implemented as a virtual machine. In this case, the secondary base station 200 (virtual machine) may operate as a virtual machine on a hypervisor and on a physical machine (hardware) including a processor, memory, and the like.

### <3.3. Technical Features>

Next, technical features of the first example embodiment will be described.

The master base station 100 (the obtaining section 141) obtains a message that requests a notification from the secondary base station 200 which performs wireless communication with the terminal apparatus 300, the notification relating to a status of at least one of a data transmission status from the secondary base station 200 to the terminal apparatus 300 and a data delivery status from the secondary base station 200 to the terminal apparatus 300. The master base station 100 (the transmission processing section 143) transmits the message to the secondary base station 200. Here, the message includes timing indication information that indicates a timing of the notification, to the secondary base station 200.

The secondary base station 200 (the reception processing section 243) receives a message from the master base station 100 which performs wireless communication with the terminal apparatus 300, the message requesting a notification relating to a status of at least one of a data transmission status from the secondary base station 200 to the terminal apparatus 300 and a data delivery status from the secondary base station 200 to the terminal apparatus 300. The secondary base station 200 (the transmission processing section 241) transmits information to the master base station 100 in accordance with the message, the information relating to a status of at least one of the data transmission status and the data delivery status. Here, the message includes timing indication information that indicates, to the secondary base station 200, a timing of the notification. In addition, the secondary base station 200 (the transmission processing section 241) transmits information relating to a status of at least one of the data transmission status and the data delivery status to the master base station 100 at the timing indicated by the timing indication information.

For example, the message is included in a Packet Data Convergence Protocol (PDCP) protocol data unit (PDU) generated through data processing regarding the PDCP layer in the master base station 100, for example, and the message is transmitted to a processing section (the processing section 140) that performs a Radio Link Control (RLC) layer processing in the secondary base station 200.

For example, the data transmission status is a data transmission status at an RLC layer. More specifically, the data transmission status is a status that is updated in response to transmission of user data from the secondary base station 200, regardless of a status report (such as an RLC status report) from the terminal apparatus 300 to the secondary base station 200.

On the other hand, for example, the data delivery status is a data delivery status at an RLC layer. More specifically, the data delivery status is a status that is updated depending on a status report (such as an RLC status report) from the terminal apparatus 300 to the secondary base station 200. In other words, the data delivery status is updated in response to reception of the status report by the secondary base station 200 from the terminal apparatus 300.

In addition, as described above, the message includes timing indication information that indicates, to the secondary base station 200, a timing of the notification. Specifically, the timing indication information may indicate that the notification timing is when the data transmission status is updated. Alternatively, the timing indication information may indicate that the notification timing is when the data delivery status is updated.

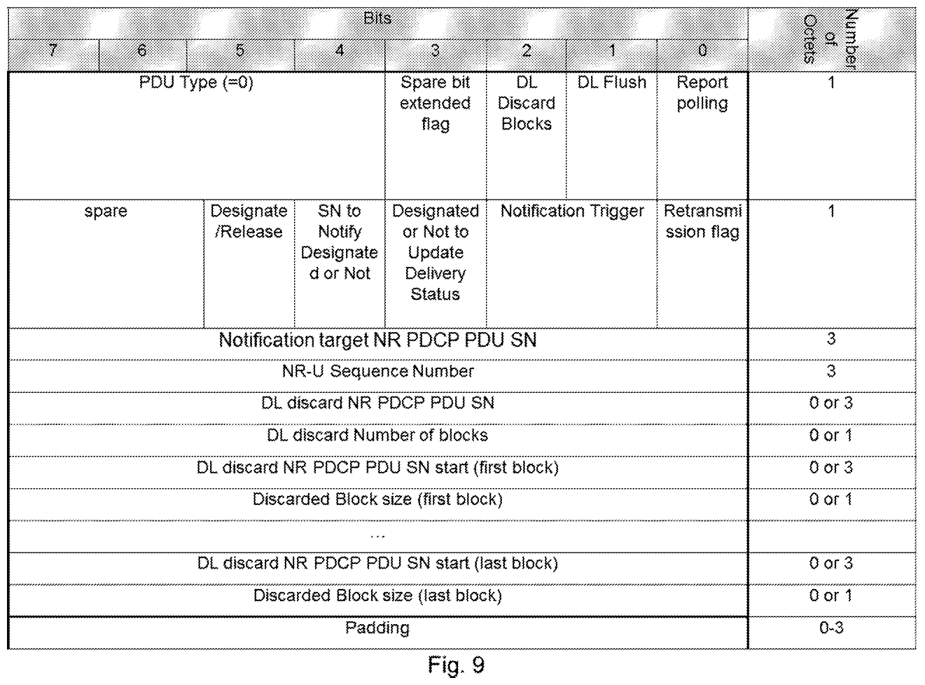

FIG. 9 is a diagram illustrating an example of a data format for transmitting the message. For example, in the data format illustrated in FIG. 9, the “Notification Trigger” corresponds to the notification timing. That is, for example, a data area corresponding to the “Notification Trigger” includes data for identifying at least one of ‘Immediately’, ‘When Transmission Status Updated’, and ‘When Delivery Status Updated’.

In addition, the master base station 100 may indicate to the secondary base station 200 to update the data delivery status. In this case, for example, the master base station 100 sets “Designated to Update Delivery Status” in a data area corresponding to “Designated or Not to Update Delivery Status” in the data format illustrated in FIG. 9. In this way, it is possible to indicate to the secondary base station 200 to update a data delivery status.

In addition, a sequence number allocated by the master base station 100 is set for data (user data) that is transmitted from the secondary base station 200 to the terminal apparatus 300. Specifically, the sequence number is a sequence number allocated through processing at the PDCP layer (such as a PDCP sequence number) in the master base station 100. In this case, for example, the message may include sequence number indication information that indicates a sequence number that is a target of notification regarding a status of at least one of the data transmission status and the data delivery status.

For example, in a case where only user data corresponding to a sequence number of 10 is treated as the target of notification, the master base station 100 may configure settings as described below, with regard to the data format illustrated in FIG. 9. Namely, the master base station 100 may set “Designate” in “Designate/Release”, set “SN to Notify Designated” in “SN to Notify Designated or Not”, and set “10” in “NR PDCP PDU SN to Notify” in the data format illustrated in FIG. 9, respectively.

### <3.4. Specific Examples>

### (1) First Specific Example

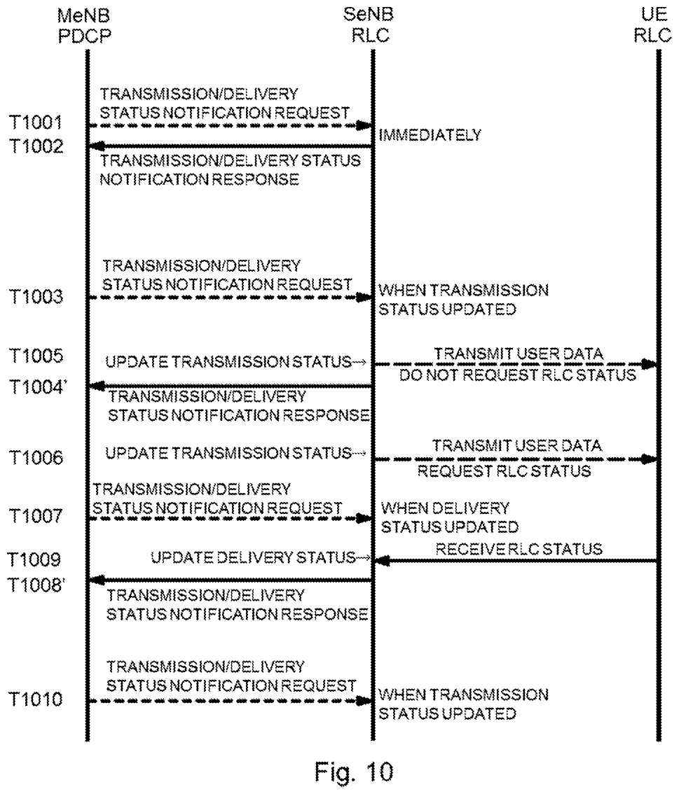

Next, with reference to FIG. 10, a first specific example will be described. FIG. 10 is a diagram illustrating a timing chart illustrating flows of processes according to the first specific example.

At a time T1001, the master base station 100 sets ‘Immediately’ in “Notification Trigger” in accordance with the data format illustrated in FIG. 9, and transmits the message (the notification request of the transmission status and/or the delivery status) to the secondary base station 200.

At a time T1002, the secondary base station 200 immediately issues a notification response (a notification response of the transmission status and/or the delivery status) to the message by using the PDCP SN in response to the message transmitted at the time T1001.

At a time T1003, the master base station 100 sets ‘When Transmission Status Updated’ in “Notification Trigger” in accordance with the data format illustrated in FIG. 9, and transmits the message (the notification request of the transmission status and/or the delivery status) to the secondary base station 200.

At a time T1005, if a condition for a trigger for requesting an RLC status is not satisfied, the secondary base station 200 does not request the RLC status but transmits user data to the terminal apparatus 300. This results in that the transmission status is updated.

At a time T1004′, the secondary base station 200 issues a notification response (a notification response of the transmission status and/or the delivery status) to the message by using the PDCP SN when the transmission status is updated. In such a way, the master base station 100 is allowed to quickly obtain the transmission status requested through the above message after the secondary base station 200 updates the transmission status.

At a time T1006, if a condition for the trigger for requesting an RLC status is satisfied, the secondary base station 200 transmits user data along with an RLC status request. This results in that the transmission status is updated.

At a time T1007, the master base station 100 sets ‘When Delivery Status Updated’ in “Notification Trigger” in accordance with the data format illustrated in FIG. 9, and transmits the message (the notification request of the transmission status and/or the delivery status) to the secondary base station 200.

At a time T1009, the secondary base station 200 receives an RLC status from the terminal apparatus 300. This results in that the delivery status is updated.

At a time T1008′, the secondary base station 200 issues a notification response (a notification response of the transmission status and/or the delivery status) to the message by using the PDCP SN when the delivery status is updated. In this way, it is possible to notify the master base station 100 of the transmission status updated at the time T1006. That is, after the delivery status is updated at RLC in the SeNB, it is possible for the master base station 100 to quickly obtain the delivery status requested through the above message.

The flows of the processes illustrated in FIG. 10 have been described above. According to the processes illustrated in FIG. 10, it is possible for the master base station 100 to quickly receive the notification requested through the above message after the secondary base station 200 updates the transmission status and/or the delivery status. In such a way, it is possible to distribute user data appropriately.

### (2) Second Specific Example

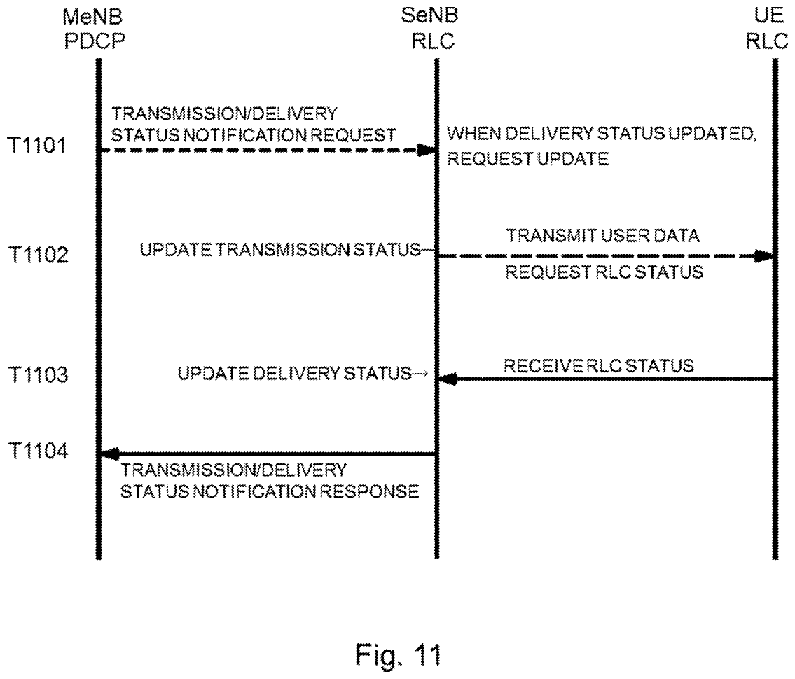

Next, with reference to FIG. 11, a second specific example will be described. FIG. 11 is a diagram illustrating a timing chart illustrating flows of a processes according to the second specific example.

At a time T1101, the master base station 100 sets ‘When Delivery Status Updated’ in “Notification Trigger” and sets “Designated to Update Delivery Status” in “Designated or Not to Update Delivery Status” in accordance with the data format illustrated in FIG. 9 and, then, transmits the message (a notification request of a transmission status and/or a delivery status).

At a time T1102, the secondary base station 200 transmits user data along with an RLC status request even if the condition for the trigger for requesting the RLC status is not satisfied.

At a time T1103, the secondary base station 200 receives an RLC status from the terminal apparatus 300. This results in that the delivery status is updated.

At a time T1104, the secondary base station 200 issues a notification response (a notification response of the transmission status and/or the delivery status) to the message by using the PDCP SN when the delivery status is updated. In such a way, the master base station 100 is allowed to quickly obtain the delivery status requested through the above message after the secondary base station 200 updates the delivery status.

### (3) Third Specific Example

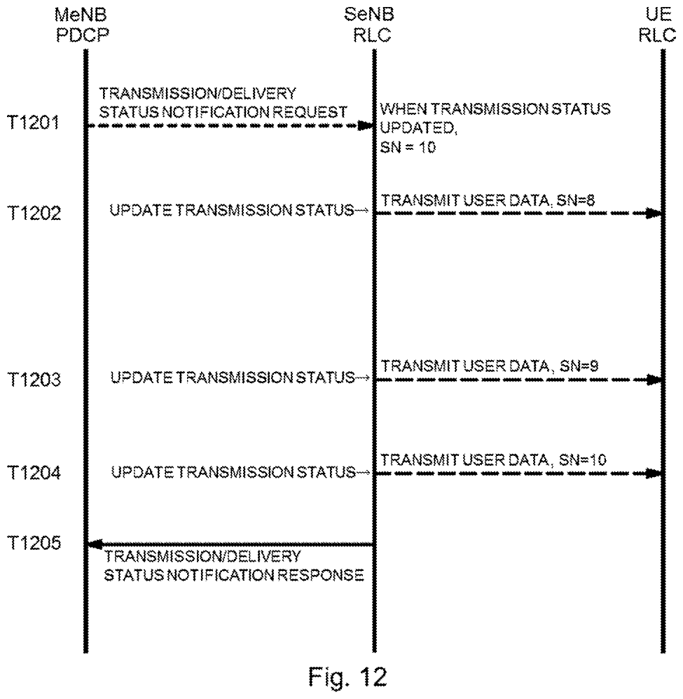

Next, with reference to FIG. 12, a third specific example will be described. FIG. 12 is a diagram illustrating a timing chart illustrating flows of processes according to the third specific example.

At a time T1201, the master base station 100 sets ‘When Transmission Status Updated’ in “Notification Trigger”, sets “Designate” in “Designate/Release”, sets “SN to Notify Designated” in “SN to Notify Designated or Not”, and sets “10” in “NR PDCP PDU SN to Notify” in accordance with the data format illustrated in FIG. 9. Then, the master base station 100 transmits the message (a notification request of a transmission status and/or a delivery status).

At a time T1202, the secondary base station 200 transmits user data having the PDCP SN of “8”. This results in that the transmission status is updated. Here, “8” that is the SN of the user data is different from “10” that is the target SN of notification. Therefore, the secondary base station 200 does not issue a notification response (a notification response of a transmission status and/or a delivery status) to the message.

At a time T1203, the secondary base station 200 transmits user data having the PDCP SN of “9”. This results in that the transmission status is updated. Here, “9” that is the SN of the user data is different from “10” that is the target SN of notification. Therefore, the secondary base station 200 does not issue a notification response (a notification response of a transmission status and/or a delivery status) to the message.

At a time T1204, the secondary base station 200 transmits user data having the PDCP SN of “10”. This results in that the transmission status is updated.

At a time T1205, the secondary base station 200 issues a notification response (a notification response of the transmission status and/or the delivery status) to the message by using the PDCP SN since the SN with which transmission status has been updated at the time T1204 is the target SN of notification.

The flows of the processes illustrated in FIG. 12 have been described above. According to the processes illustrated in FIG. 12, it is possible for the master base station 100 to immediately obtain a transmission status of a designated PDCP PDU.

### (4) Another Specific Example

Note that, various kinds of example alternations are possible in addition to the above-described examples. For example, the master base station 100 may repeatedly transmit the message (a notification request of a transmission status and/or a delivery status) by setting “Designate” in “Designate/Release” in accordance with the data format illustrated in FIG. 9. This enables the master base station 100 to immediately obtain transmission statuses and/or delivery statuses of multiple PDCP PDUs. In addition, it is also possible to request the transmission statuses and/or the delivery statuses of the multiple PDCP PDUs by transmitting the message (the notification request of the transmission status and/or the delivery status) only once. In addition, it is possible to cancel some or all of notification requests of a transmission status and/or a delivery status that have been made in the past, by setting “Release” in “Designate/Release” in accordance with the data format illustrated in FIG. 9. In addition, it is possible to use, as a condition for the notification response, remaining capacity of a buffer size for user data in the secondary base station 200. That is, the master base station 100 may transmit indication information regarding a threshold of the remaining capacity of the buffer to the secondary base station 200 by including the indication information in the message. In such a way, it is possible for the secondary base station 200 to issue a notification response (a notification response of a transmission status and/or a delivery status) to the message, only in a case where the remaining capacity of the buffer falls below the threshold as indicated by the master base station 100.

### 4. Second Example Embodiment

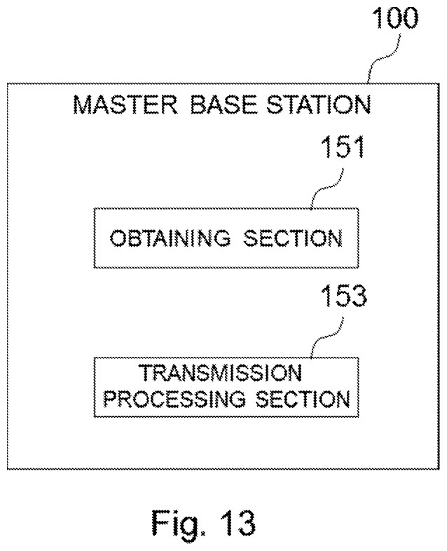

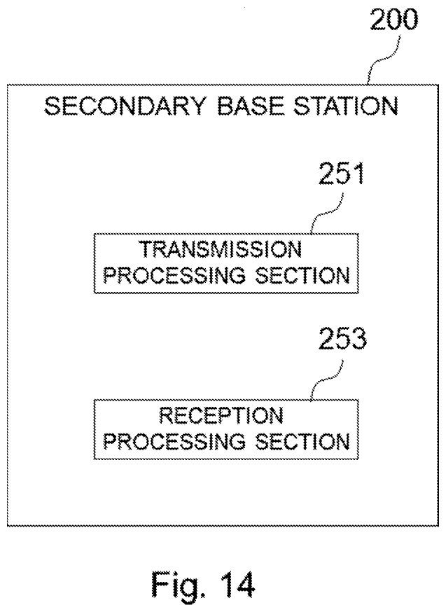

Next, a second example embodiment of the present invention will be described with reference to FIG. 13 and FIG. 14. The above-described first example embodiment is a specific example embodiment, whereas the second example embodiment is a more generalized example embodiment.

### <4.1. Configuration of Master Base Station 100>

First, with reference to FIG. 13, an example of a configuration of a master base station 100 according to the second example embodiment will be described. FIG. 13 is a block diagram illustrating an example of a schematic configuration of the master base station 100 according to the second example embodiment. With reference to FIG. 13, the master base station 100 includes an obtaining section 151 and a transmission processing section 153. Specific operations of the obtaining section 151 and the transmission processing section 153 will be described later in detail.

The obtaining section 151 and transmission processing section 153 may be implemented with the same processor or may be implemented with respective different processors. The obtaining section 151 and the transmission processing section 153 may include a memory that stores a program (instructions) and one or more processors that are capable of executing the program (instructions). The one or more processors may perform operations of the obtaining section 151 and the transmission processing section 153. The program may be a program for causing the processor to execute the operations of the obtaining section 151 and the transmission processing section 153.

Note that the above-described respective processors may be virtual processors that are implemented with hypervisors or the like installed on a general-purpose computer, for example. In addition, the above-described respective memories may be virtual memories that are implemented with hypervisors or the like installed on a general-purpose computer, for example.

### <4.2. Configuration of Secondary Base Station 200>

Next, with reference to FIG. 14, an example of a configuration of a secondary base station 200 according to the second example embodiment will be described. FIG. 14 is a block diagram illustrating an example of a schematic configuration of the secondary base station 200 according to the second example embodiment. With reference to FIG. 14, the secondary base station 200 includes a transmission processing section 251 and a reception processing section 253. Specific operations of the transmission processing section 251 and the reception processing section 253 will be described later in detail.

The transmission processing section 251 and the reception processing section 253 may be implemented with the same processor or implemented with respective different processors. The transmission processing section 251 and the reception processing section 253 may include a memory that stores a program (instructions) and one or more processors that are capable of executing the program (instructions). The one or more processors may perform operations of the transmission processing section 251 and the reception processing section 253. The program may be a program for causing the processor to execute the operations of the transmission processing section 251 and the reception processing section 253.

Note that the above-described respective processors may be virtual processors that are implemented with hypervisors or the like installed on a general-purpose computer, for example.

In addition, the above-described respective memories may be virtual memories that are implemented with hypervisors or the like installed on a general-purpose computer, for example.

### <4.3. Technical Features>

Next, technical features of the second example embodiment will be described.

According to the second example embodiment, the master base station 100 (the obtaining section 151) obtains a message that requests a notification from the secondary base station 200 which performs wireless communication with the terminal apparatus 300, the notification relating to a status of at least one of a data transmission status from the secondary base station 200 to the terminal apparatus 300 and a data delivery status from the secondary base station 200 to the terminal apparatus 300. The master base station 100 (the transmission processing section 153) transmits the message to the secondary base station 200. Here, the message includes timing indication information that indicates to the secondary base station 200 a timing of the notification.

For example, the obtaining section 151 may perform the operation of the obtaining section 141 according to the first example embodiment. In addition, the transmission processing section 153 may perform the operation of the transmission processing section 143 according to the first example embodiment.

The secondary base station 200 (the reception processing section 253) receives a message from the master base station 100 which performs wireless communication with the terminal apparatus 300, the message requesting a notification relating to a status of at least one of a data transmission status from the secondary base station 200 to the terminal apparatus 300 and a data delivery status from the secondary base station 200 to the terminal apparatus 300. The secondary base station 200 (the transmission processing section 251) transmits information to the master base station 100 in accordance with the message, the information relating to a status of at least one of the data transmission status and the data delivery status. Here, the message includes timing indication information that indicates to the secondary base station 200 a timing of the notification. In addition, the secondary base station 200 (the transmission processing section 251) transmits the information relating to a status of at least one of the data transmission status and the data delivery status, to the master base station 100 at the timing indicated by the timing indication information.

For example, the reception processing section 253 may perform the operation of the reception processing section 243 according to the first example embodiment. In addition, the transmission processing section 251 may perform the operation of the transmission processing section 241 according to the first example embodiment.

The second example embodiment has been described above. According to the second example embodiment, for example, it will be possible for a master base station to obtain, at an appropriate timing, a transmission status or a delivery status of data transmitted from a secondary base station to a terminal apparatus.

### 5. Another Example Embodiment

Though the example embodiments of the present invention have been described above, the present invention is not limited to the above-described example embodiments. It will be understood by those of ordinary skill in the art that these example embodiments are illustrative only and that various alterations can be done without departing from the scope and spirit of the present invention.

For example, the steps in the processes described in the present Specification do not have to be performed chronologically in the order illustrated in the sequence diagrams. For example, steps in a process may be performed in a different order than the order illustrated in a sequence diagram or may be performed in parallel. In addition, some of steps in a process may be removed or further steps may be added to the process.

In addition, it is also possible to provide an apparatus including the constituent elements (such as the obtaining section, the transmission processing section, and/or the reception processing section) of the master base station described in the present Specification (such as one or more apparatuses (or units) among multiple apparatuses (or units) constituting the master base station, or a module for one of the multiple apparatuses (or units)). It is possible to provide an apparatus including the constituent elements (such as the transmission processing section and/or the reception processing section) of the secondary base station described in the present Specification (such as a module for the secondary base station). In addition, it is also possible to provide methods including the processes of the constituent elements, and it is also possible to provide programs for causing the processors to execute the processes of the constituent elements. Furthermore, it is also possible to provide a computer-readable non-transitory recording medium (non-transitory computer readable medium) having recorded thereon the programs. It is apparent that such apparatuses, modules, methods, programs and a computer-readable non-transitory recording medium are also included in the present invention.

Some or all of the above-described example embodiments can be described as in the following Supplementary Notes, but are not limited to the following.

### (Supplementary Note 1)

A master base station which performs wireless communication with a terminal apparatus, the master base station comprising:

an obtaining section configured to obtain a message that requests a notification from a secondary base station which performs wireless communication with the terminal apparatus, the notification relating to a status of at least one of a data transmission status from the secondary base station to the terminal apparatus and a data delivery status from the secondary base station to the terminal apparatus; and

a transmission processing section configured to transmit the message to the secondary base station,

wherein the message includes timing indication information that indicates a timing of the notification to the secondary base station.

### (Supplementary Note 2)

The master base station according to Supplementary Note 1, wherein the timing indication information indicates that the timing of the notification is when the data transmission status is updated.

### (Supplementary Note 3)

The master base station according to Supplementary Note 1, wherein the timing indication information indicates that the timing of the notification is when the data delivery status is updated.

### (Supplementary Note 4)

The master base station according to Supplementary Note 3, wherein the data delivery status is updated in response to a status report being received by the secondary base station from the terminal apparatus.

### (Supplementary Note 5)

The master base station according to any one of Supplementary Note 1 to Supplementary Note 4, wherein:

a sequence number allocated by the master base station is set for data to be transmitted from the secondary base station to the terminal apparatus; and

the message includes sequence number indication information that indicates a sequence number that is a target of notification relating to a status of at least one of the data transmission status and the data delivery status.

### (Supplementary Note 6)

The master base station according to any one of Supplementary Note 1 to Supplementary Note 5, wherein the data transmission status is a data transmission status at a Radio Link Control (RLC) layer.

### (Supplementary Note 7)

The master base station according to any one of Supplementary Note 1 to Supplementary Note 6, wherein the data delivery status is a data delivery status at a Radio Link Control (RLC) layer.

### (Supplementary Note 8)

A secondary base station which performs wireless communication with a terminal apparatus, the secondary base station comprising:

a reception processing section configured to receive a message from a master base station which performs wireless communication with the terminal apparatus, the message requesting a notification relating to a status of at least one of a data transmission status from the secondary base station to the terminal apparatus and a data delivery status from the secondary base station to the terminal apparatus; and

a transmission processing section configured to transmit information to the master base station in accordance with the message, the information relating to a status of at least one of the data transmission status and the data delivery status,

wherein the message includes timing indication information that indicates a timing of the notification to the secondary base station, and

the transmission processing section transmits the information relating to a status of at least one of the data transmission status and the data delivery status to the master base station at the timing indicated by the timing indication information.

### (Supplementary Note 9)

A method performed by a master base station which performs wireless communication with a terminal apparatus, the method comprising:

obtaining a message that requests a notification from a secondary base station which performs wireless communication with the terminal apparatus, the notification relating to a status of at least one of a data transmission status from the secondary base station to the terminal apparatus and a data delivery status from the secondary base station to the terminal apparatus; and

transmitting the message to the secondary base station,

wherein the message includes timing indication information that indicates a timing of the notification to the secondary base station.

### (Supplementary Note 10)

A method performed by a secondary base station which performs wireless communication with a terminal apparatus, the method comprising:

receiving a message from a master base station which performs wireless communication with the terminal apparatus, the message requesting a notification relating to a status of at least one of a data transmission status from the secondary base station to the terminal apparatus and a data delivery status from the secondary base station to the terminal apparatus; and

transmitting information to the master base station in accordance with the message, the information relating to a status of at least one of the data transmission status and the data delivery status,

wherein the message includes timing indication information that indicates a timing of the notification to the secondary base station, and

when transmitting the information relating to a status of at least one of the data transmission status and the data delivery status, the information relating to a status of at least one of the data transmission status and the data delivery status is transmitted to the master base station at the timing indicated by the timing indication information.

### (Supplementary Note 11)

A program to be executed by a master base station which performs wireless communication with a terminal apparatus, the program causing the master base station to:

obtain a message that requests a notification from a secondary base station which performs wireless communication with the terminal apparatus, the notification relating to a status of at least one of a data transmission status from the secondary base station to the terminal apparatus and a data delivery status from the secondary base station to the terminal apparatus; and

transmit the message to the secondary base station,

wherein the message includes timing indication information that indicates a timing of the notification to the secondary base station.

### (Supplementary Note 12)

A program to be executed by a secondary base station which performs wireless communication with a terminal apparatus, the program causing the secondary base station to:

receive a message from a master base station which performs wireless communication with the terminal apparatus, the message requesting a notification relating to a status of at least one of a data transmission status from the secondary base station to the terminal apparatus and a data delivery status from the secondary base station to the terminal apparatus; and

transmit information to the master base station in accordance with the message, the information relating to a status of at least one of the data transmission status and the data delivery status,

wherein the message includes timing indication information that indicates a timing of the notification to the secondary base station, and

when transmitting the information relating to a status of at least one of the data transmission status and the data delivery status, the information relating to a status of at least one of the data transmission status and the data delivery status is transmitted to the master base station at the timing indicated by the timing indication information.

### (Supplementary Note 13)

A computer-readable non-transitory recording medium having recorded thereon a program to be executed by a master base station which performs wireless communication with a terminal apparatus, the program causing the master base station to:

obtain a message that requests a notification from a secondary base station which performs wireless communication with the terminal apparatus, the notification relating to a status of at least one of a data transmission status from the secondary base station to the terminal apparatus and a data delivery status from the secondary base station to the terminal apparatus; and

transmit the message to the secondary base station,

wherein the message includes timing indication information that indicates a timing of the notification to the secondary base station.

### (Supplementary Note 14)

A computer-readable non-transitory recording medium having recorded thereon a program to be executed by a secondary base station which performs wireless communication with a terminal apparatus, the program causing the secondary base station to:

receive a message from a master base station which performs wireless communication with the terminal apparatus, the message requesting a notification relating to a status of at least one of a data transmission status from the secondary base station to the terminal apparatus and a data delivery status from the secondary base station to the terminal apparatus; and

transmit information to the master base station in accordance with the message, the information relating to a status of at least one of the data transmission status and the data delivery status,

wherein the message includes timing indication information that indicates a timing of the notification to the secondary base station, and

when transmitting the information relating to a status of at least one of the data transmission status and the data delivery status, the information relating to a status of at least one of the data transmission status and the data delivery status is transmitted to the master base station at the timing indicated by the timing indication information.

This application claims priority based on Japanese Patent Application No. 2018-109733 filed on Jun. 7, 2018, the entire disclosure of which is incorporated herein.

In a mobile communication system, it is possible for a master base station to obtain, at an appropriate timing, a transmission status or a delivery status of data transmitted from a secondary base station to a terminal apparatus.

What is claimed is:

1. A master base station which performs wireless communication with a terminal apparatus, the master base station comprising:
a controller configured to:
obtain a message that requests a notification from a secondary base station which performs wireless communication with the terminal apparatus, the notification relating to a status of at least one of a data transmission status from the secondary base station to the terminal apparatus and a data delivery status from the secondary base station to the terminal apparatus; and
transmit the message to the secondary base station,
wherein the message includes timing indication information that indicates a timing of the notification to the secondary base station.

2. The master base station according to claim 1, wherein the timing indication information indicates that the timing of the notification is when the data transmission status is updated.

3. The master base station according to claim 1, wherein the timing indication information indicates that the timing of the notification is when the data delivery status is updated.

4. The master base station according to claim 3, wherein the data delivery status is updated in response to a status report being received by the secondary base station from the terminal apparatus.

5. The master base station according to claim 1, wherein:
a sequence number allocated by the master base station is set for data to be transmitted from the secondary base station to the terminal apparatus; and
the message includes sequence number indication information that indicates a sequence number that is a target of notification relating to a status of at least one of the data transmission status and the data delivery status.

6. The master base station according to claim 1, wherein the data transmission status is a data transmission status at a Radio Link Control (RLC) layer.

7. The master base station according to claim 1, wherein the data delivery status is a data delivery status at a Radio Link Control (RLC) layer.

8. A secondary base station which performs wireless communication with a terminal apparatus, the secondary base station comprising:
a controller configured to:
receive a message from a master base station which performs wireless communication with the terminal apparatus, the message requesting a notification relating to a status of at least one of a data transmission status from the secondary base station to the terminal apparatus and a data delivery status from the secondary base station to the terminal apparatus; and
transmit information to the master base station in accordance with the message, the information relating to a status of at least one of the data transmission status and the data delivery status,
wherein the message includes timing indication information that indicates a timing of the notification to the secondary base station, and
the controller is configured to transmit the information relating to a status of at least one of the data transmission status and the data delivery status to the master base station at the timing indicated by the timing indication information.

9. A method performed by a master base station which performs wireless communication with a terminal apparatus, the method comprising:
obtaining a message that requests a notification from a secondary base station which performs wireless communication with the terminal apparatus, the notification relating to a status of at least one of a data transmission status from the secondary base station to the terminal apparatus and a data delivery status from the secondary base station to the terminal apparatus; and
transmitting the message to the secondary base station,
wherein the message includes timing indication information that indicates a timing of the notification to the secondary base station.
